(19) United States
(12) Patent Application Publication
(10) Pub. No.: US 2026/0273315 A1
(43) Pub. Date: Sep. 17, 2026

(54) Safety Anchorage

(71) Applicant: Z-Tex Safety LLC, Elgin, TX (US)

(72) Inventor: Oscar Zamarron, Elgin, TX (US)

(73) Assignee: Z-Tex Safety LLC, Elgin, TX (US)

(21) Appl. No.: 19/079,550

(22) Filed: Mar. 14, 2025

(51) Int. Cl. A62B 35/00

(52) U.S. Cl. CPC A62B 35/0068

(57) ABSTRACT

A construction site safety anchorage comprises a body having a generally trapezoidal body shape and substantial weight, a plurality of recessed, arcuate metal anchors oriented in pockets to optimize worker safety during use, a high-friction bottom surface, slots on the bottom of the invention for use lifting the invention using a forklift, a steel-framed bottom surface, a plurality of incorporated threaded holes for attaching threaded pegs for additional friction and stability, chamfered edges, a recessed, acuate metal anchor on the top of the invention for lifting the invention and a drain hole disposed vertically through the invention.

### BACKGROUND OF THE INVENTION

Construction sites can be dangerous places to work. In many construction sites, a worker may find it necessary to work on, near or over a significant drop off, commonly referred to as a leading edge, creating a risk of falling. In the event of a fall, the worker could be seriously injured or killed. In many construction sites, a guard rail or other “barrier” type of fall prevention system at the leading edge can be employed. In other situations, however, it is necessary to provide an employee with a body harness, which is further connected to a tether or lanyard and further connected to an anchorage. Connectors between body harnesses and tether are those commonly known in the industry, such as carabiners, buckles or similar devices. For the anchorage, it is possible to connect the body harness and tether to a hard point on the construction project itself (such an I-beam or girder in a building or other structure under construction), but in many cases that is not possible. Further, the only suitable hard point may be located at such a distance from the leading edge that the tether may need to be placed across the work site, increasing the risk to worker safety instead of reducing it.

Likewise, in the event of a fall by a worker, it may be necessary to affix a second worker quickly to a hard point via a tether and body harness to attempt a rescue or provide other assistance to the fallen worker. It may not be practical to use the first hard point. A second hard point may be needed very quickly, such that the risk to a fallen worker is increased unless a second worker is put into place to assist the first worker immediately.

A heavy object placed at a work site acting as an anchorage may be suitable to act as a moveable hard point for one or more tethers, but this is not practical unless the heavy object is properly configured to be used to anchor these one or more tethers. Safety at a construction site can be a matter of life or death for workers. A jury-rigged safety device could provide a false level of safety to workers and lead to worse problems than no safety device.

There is a need for a durable, dedicated anchorage which is moveable when necessary but likewise capable of securing one or more workers to prevent a fall by being immovable when placed in a work location and used in its designed manner. The needed anchorage must be suitable to increase worker safety at a work site while not creating any unreasonable form of risk. The present invention meets those needs.

### BRIEF DESCRIPTION OF THE INVENTION

The invention is a generally solid block of poured concrete formed in the shape, in a preferred embodiment, of a trapezoidal solid. The trapezoidal shape provides a low center of gravity along with a broad base to reduce the risk of tipping during even extreme conditions of use.

The invention is typically constructed using a frame in the shape of the invention, with various components thereof installed in the frame. A concrete mix or other form of moldable material is poured into the frame. Most commonly, a concrete mix is used and is referred to in this specification as the normal substance comprising the bulk of the invention. The concrete mix is allowed to set and the frame is removed. The concrete may be, preferentially, reinforced with a plurality of internally disposed reinforcement bar (“rebar”) elements to help maintain structural integrity of the invention, to help retain one or more metal anchors to which a lanyard may be attached and to help retain a davit mount and anchor. As described in more detail below, the invention has a top, a bottom and four sides, as those terms are commonly understood relative to a solid, roughly rectangular or trapezoidal object. The invention can be further described in terms of a height, a width and a length, with the length longer than the width. The height of the invention is the distance from the bottom to the top. Generally, the height is equal to or smaller than the width at the bottom of the invention. The length is the distance along the bottom of one long side of the invention. The width is the length along the bottom of one short side of the invention. The four sides of the invention are generally trapezoidal in shape. To sides along the length are set generally opposite to each other at an angle relative to the direction of the height. The two sides along the length of the invention are generally referred to as the “sides” of the invention.

Across the width, the other two sides are trapezoidal in shape and are also set generally opposite to each other at an angle relative to the vertical height. These elements are generally referred to as the “ends” of the invention. The sides and the ends connect to the bottom at an angle, with the angle between the bottom and the sides approximately the same as the angle between the bottom and the ends, although this is not required. The sides and ends connect to the top at similar angles. Each angle between the top and sides or ends is generally obtuse while each angle between the bottom and sides or ends is generally acute. These angles vary off a right angle by approximately the same angle over or under 90 degrees. For example, if the acute angle between the bottom and sides or ends is approximately 85 degrees, the obtuse angle between the top and sides or ends will be approximately 95 degrees.

The acute angle between the bottom and each side and end may be between 80 degrees and 89 degrees. The obtuse angle between the top and each side and end may be between 91 degrees and 100 degrees.

In this form, the bottom of the invention is larger than the top. This results in a center of gravity of the invention, determinable by a mathematical calculation, closer to the bottom than to the top of the invention. This increases the stability of the invention during use.

In an embodiment, the generally trapezoidal shape of the invention may include a top feature in the form of an integral approximately rectangular or trapezoidal solid element positioned upward of the generally trapezoidal solid body of the invention.

The edges of the invention may be chamfered to reduce the risk of injury to a worker making contact with the edge of the invention.

The invention is sized to be a sufficient weight to remain in a desired placement during use. In particular, the weight of the invention must be sufficient for the invention to remain stationary even when used to stop the fall of a worker over a leading edge. That is, it must not move when a worker affixed to it falls from a leading edge and the invention is used to stop the worker's further fall. In a preferred embodiment, the weight of the invention is approximately 5,000 pounds. In some embodiments, the weight of the invention may be approximately 3,000 pounds while in others it may be 7,000 pounds or more. In an embodiment weighing 3,000 pounds, fewer metal anchors (described below) may be used compared to the number in a heavier embodiment.

The two ends of the invention are generally the primary working elements of the invention. In the preferred embodiment, two generally hemispherically-shaped pockets are disposed in each end of the invention. Each pocket is disposed below the midpoint of the height of each end of the invention. In various embodiments, each pocket may be generally circular or elliptical in shape and have a depth in the end in which it is disposed sufficient to permit functional use. An arcuate metal anchor is disposed outwardly in each pocket in an approximately horizontal orientation. The metal anchor may be purchased or made to a custom size and shape. Each pocket must be deep enough to allow enough of the metal anchor to be exposed functionally within the pocket to allow a carabiner to be easily clipped to the exposed portion of the metal anchor in the pocket. In a preferred embodiment, each disposed metal anchor is angled slightly upward in the outward direction relative to the bottom, which is generally flat and horizontal. Each metal anchor is optimally disposed in a pocket perpendicularly to the end in which the pocket is disposed.

Each metal anchor is made from a length of a solid, durable metal. Further, each metal anchor comprises a rounded curve forming an angle of approximately 60 degrees. In addition, the length of durable metal has two ends, each of which is formed in the shape of a solid spherical or hemispherical expansion. When each of the two ends is embedded in the concrete body of the invention, the shape of the metal anchor and the two solid expansions prevent the metal anchor from being pulled from the concrete. Rebar may be disposed in the concrete proximal to each metal anchor to provide additional structural support.

A similar circular or elliptical pocket is disposed at a center point of the top of the invention. This pocket is referred to as the top pocket and is commonly identical in shape and size to the end pockets described above. Therein, a metal anchor as previously described is disposed perpendicularly to the top. The curved portion of the metal anchor is exposed in the top pocket. This metal anchor is used to permit lifting of the invention for moving or reorientation. The top pocket must be sized and the metal anchor must be positioned such that a hook attached to a crane hook or hoist may be attached to the metal anchor in the top pocket. This metal anchor is disposed directly over the center of gravity of the invention to permit stability during lifting. A drain hole is disposed in the top pocket extending vertically downwardly through the body of the invention to the bottom to permit rain or other liquids to drain away instead of accumulating in the top pocket.

Along the bottom, two slots are disposed through the invention from one side to the other. The slots are positioned, sized and shaped to allow the invention to be lifted with a forklift. Such forklifts and slots therefore are well known in industry. Further disposed in the bottom are a plurality of threaded mounting holes into which threaded pegs may be inserted to provide additional stability and friction for the invention. The bottom portion of the invention may be installed in or encased in a partial or full steel frame to protect the edges of the bottom of the invention from damage and to provide structural support for the invention. If the bottom steel frame is used, a plurality of holes may be disposed in the steel frame to permit threaded pegs to be installed in the invention.

In general, the trapezoidal shape of the invention creates a wide bottom having a large footprint between the invention and the surface on which it is set. The trapezoidal shape of the invention likewise creates a low center of gravity, providing stability during use. Metal anchors are positioned to take advantage of the low center of gravity of the invention while further permitting more than one worker at a time to attach a tether to the invention.

Other elements and features of the invention are described hereinbelow.

### FIGURES

FIG. 1 depicts a side view of the invention.

FIG. 2 depicts an end view of the invention.

FIG. 3 depicts a top view of the invention.

FIG. 4 depicts an isometric view of the invention.

FIG. 5 depicts a detail of the top of the invention further depicting a lifting anchor, top pocket and drain hole of the invention.

FIG. 6 depicts a davit attached to a davit mount on one end of the invention for use.

FIG. 7 depicts a detail of a representative end pocket of the invention depicting a metal anchor in place.

FIG. 8 depicts a side view detail of one end of the invention showing a disposed metal anchor.

FIG. 9 depicts a top view detail of the invention showing two metal anchors in place in an end of the body of the invention.

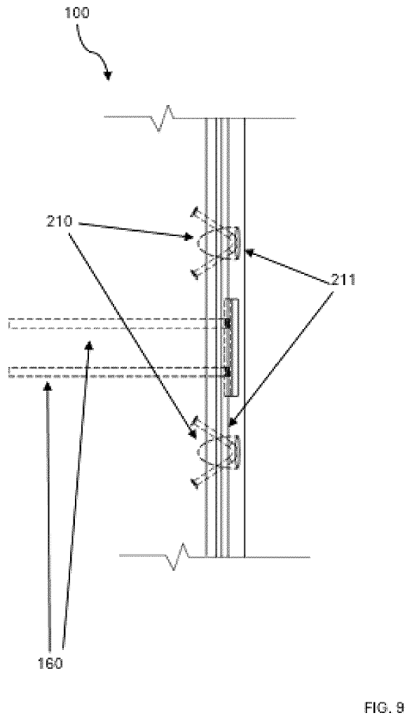

FIG. 10 depicts an isometric view of a representative metal anchor of the invention.

FIG. 11 depicts a bottom view of the invention.

FIG. 12 depicts an isometric view of a representative threaded peg used with the invention.

FIG. 13 depicts an isometric view of the position of rebar elements in a representative embodiment disposed in the body of the invention.

FIG. 14 depicts a side view of the position of rebar elements of a representative embodiment disposed in the body of the invention.

FIG. 15 depicts an isometric view of the steel frame of the invention.

### DETAILED DESCRIPTION OF THE INVENTION

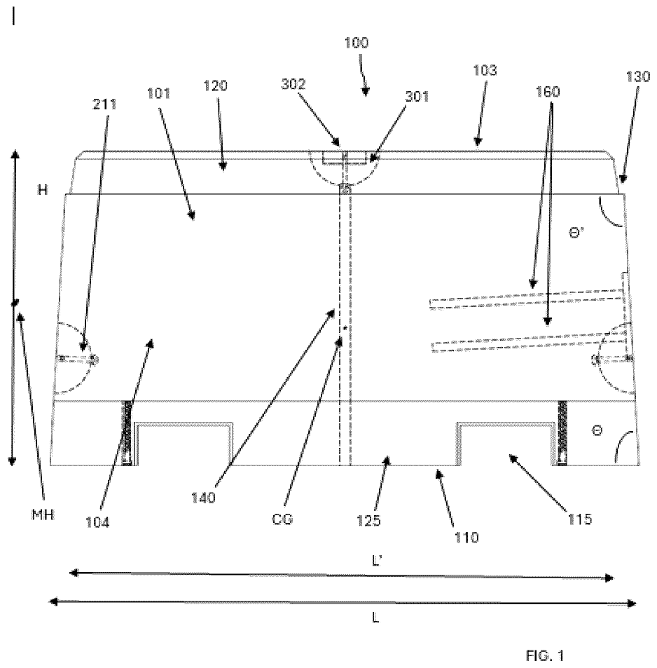

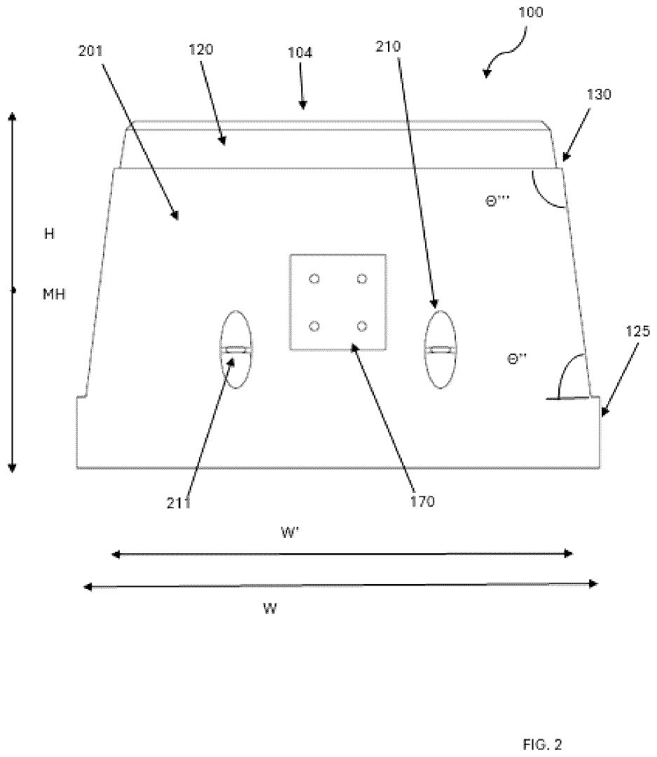

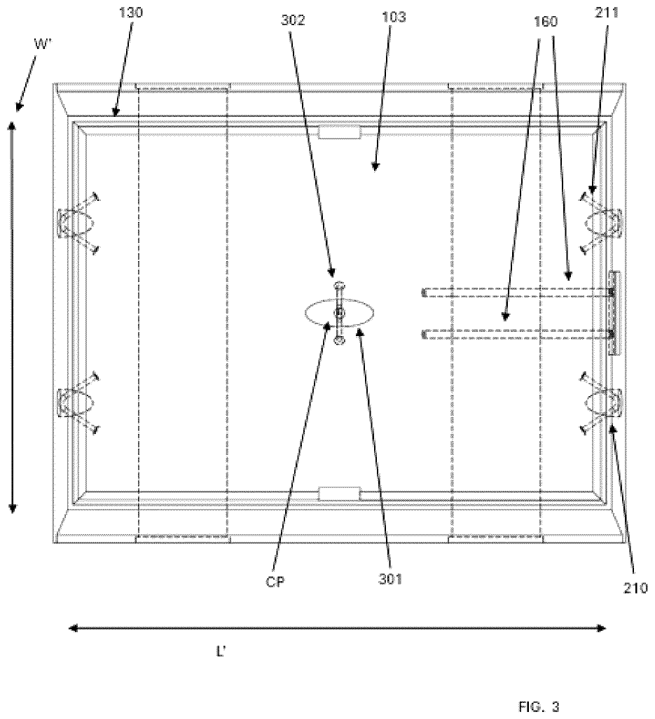

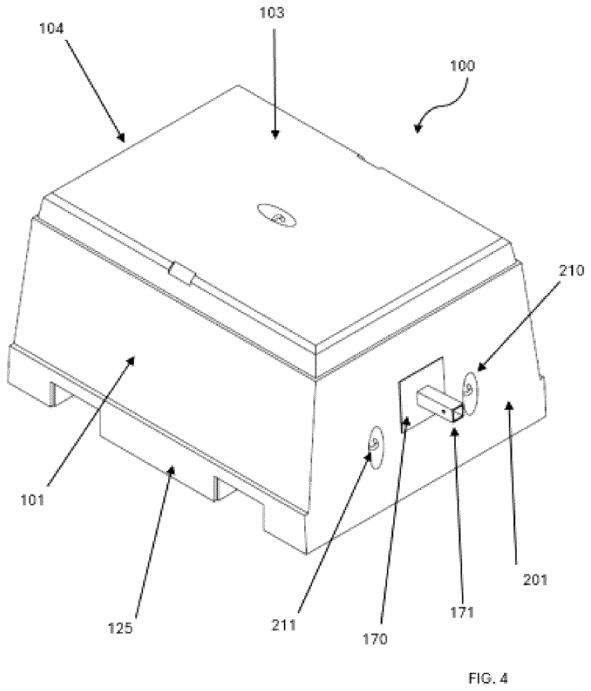

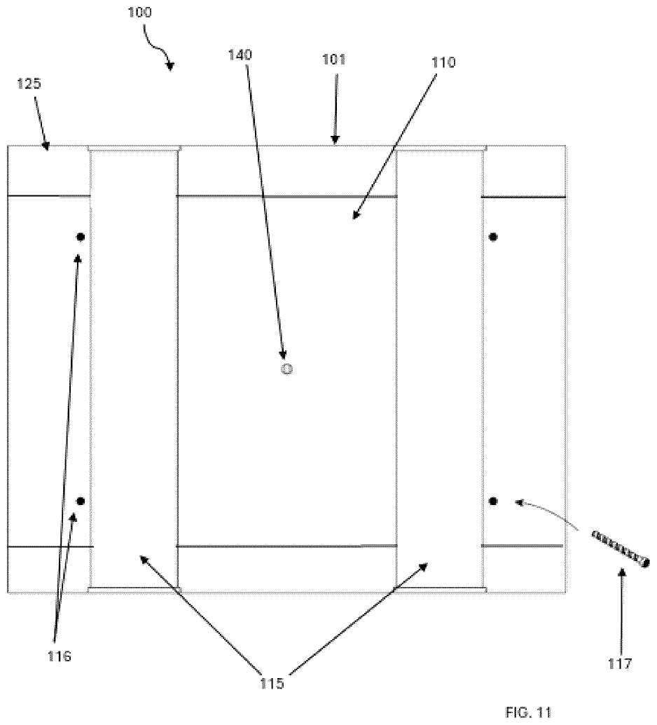

Reference is made to FIG. 4, which depicts an isometric view of invention 100, and FIG. 1, a side view of invention 100 further depicting in dotted lines the position of various internal elements of the invention. Invention 100 takes the shape generally of a trapezoidal solid having a top 103 (depicted in FIG. 3), two ends 201 (with one end 201 depicted in FIG. 2), two sides 101 (with one side depicted in FIG. 4) and a bottom 110 (depicted in FIG. 11). These define generally the body 104 of invention 100.

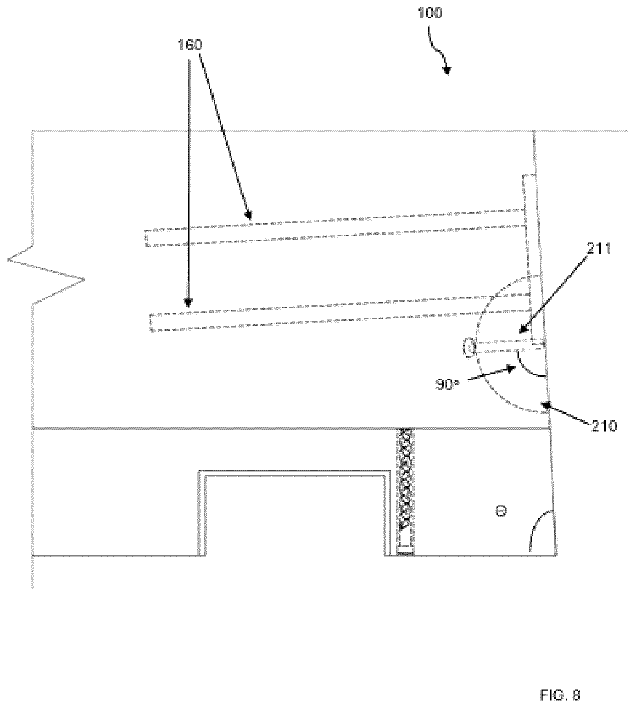

FIG. 1 depicts a first side 101 having a generally trapezoidal shape. Invention 100 has a height H. Height H has a midpoint MH, which is midway between bottom 110 and top 103. Side 101 has a bottom length L and a top length L′. A second side 101 having the same dimensions as side 101 is disposed on the opposing side of invention 100. Referring also to FIG. 3, invention 100 has a top 103, which is generally rectangular in shape. Top 103 is defined generally by top length L′ and top width W′. Top 103 has a center point C. Top length L′ of side 101 is shorter than bottom length L in disclosed embodiments herein. As a result, and as depicted in FIG. 1, the angle Θ, which is an acute angle between approximately 80 degrees to 89 degrees, is created in each bottom corner of side 101. This angle Θ is depicted in a detail in FIG. 8. Each top corner of side 101 takes the shape of an obtuse angle Θ′ between approximately 91 degrees to 100 degrees. FIGS. 1, 2 and 4 depict a steel frame 125 used to encase and support a portion of the body 104 of invention 100.

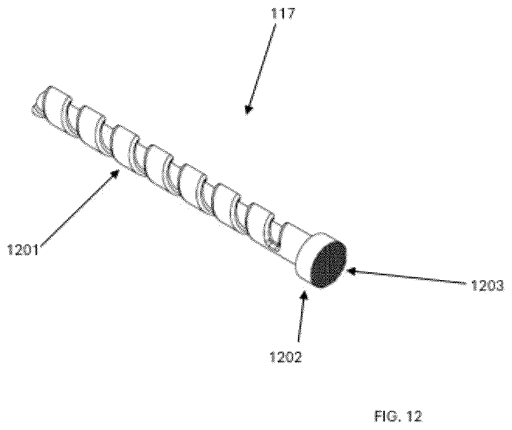

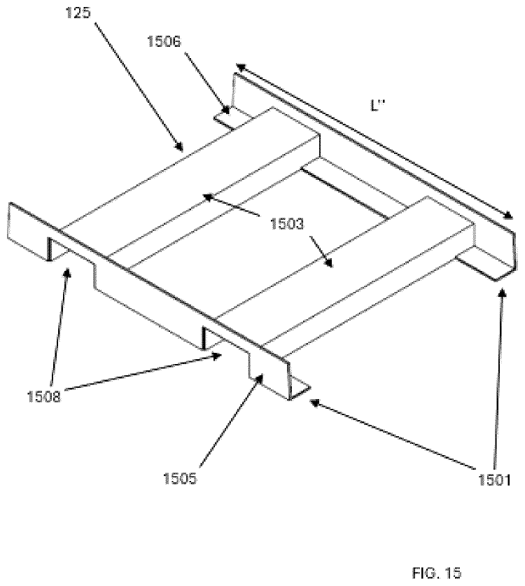

Referring to FIG. 11, invention 100 has a bottom 110. Bottom 110 is generally rectangular in shape. Bottom 110 may be formed from the poured concrete of the body 104 of the invention 100 or be encased in a steel frame 125 covering a portion of bottom 110 and a portion of sides 101 proximal to bottom 110. Bottom 110 has a length and a width, being the same length L as side 101 depicted in FIG. 1 and width W of end 201 depicted in FIG. 2. Height H is generally equal to or small than bottom width W. When steel frame 125 is used on body 104, steel frame 125 has the same dimensions as described herein. For simplicity, bottom 110 may be described without specific reference to steel frame 125 except where relevant. Disposed into bottom 110 are two spaced lift slots 115. Lift slots 115 take the form of lift slots commonly known in the industry for use with forklifts. Lift slots 115 are disposed from first side 101 to second side 101 to provide stable openings into which forklift forks may be inserted for lifting invention 100 for transport to a location for use on site. Also disposed in bottom 110 are a plurality of threaded mounting holes 116 suitable for inserting into each a threaded peg 117 (FIG. 12), which may be used to increase the stability of the invention 100 during use and likewise increase friction between the invention 100 and the surface on which it is used. When steel frame 125 is used with invention 100, four through-holes (not numbered) may be disposed in steel frame 125 in position to allow the used of treaded pegs 117. Likewise, if steel frame 125 is used with invention 100, the shape of steel frame 125 includes lift slots 115 therein (as described in FIG. 15).

Referring to FIG. 12, a representative threaded peg 117 is depicted. Threaded peg 117 is comprised of a threaded portion 1201 and a cylindrical or hexagonal head 1202. Threaded portion 1201 may be threaded into a mounting hole 116 such that cylindrical head 1202 is disposed between the invention 100 and the ground on which the invention 100 is placed for use. The surface of cylindrical head 1202 disposed between mounting peg 117 and the ground has disposed thereon a high friction surface 1203. Threaded pegs 117 may be used to level invention 100 during use by adjusting the depth in which each is threaded into mounting holes 116.

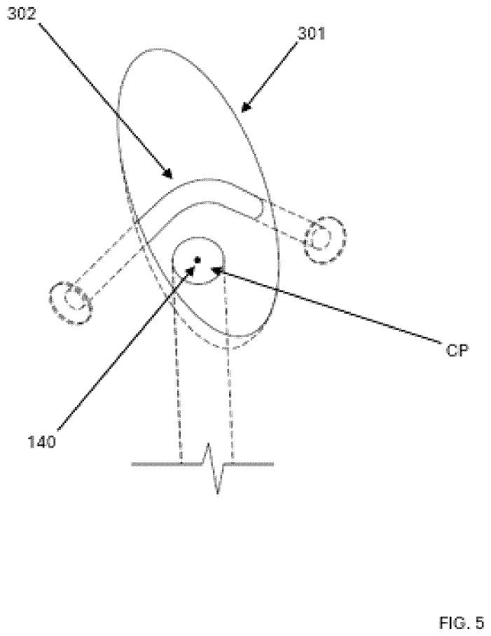

As depicted in FIG. 1, and referring also to FIG. 3, a top pocket 301 is disposed in top 103. Top pocket 301 is further depicted in FIG. 5. Top pocket 301 may be an elliptical or circular hemispherical access cavity having a length, width and depth sufficient to permit working access to a durable solid metal anchor 302 partially disposed in top pocket 301 in a manner which allows a tool, such as a crane hook, to be removably attached to metal anchor 302. In FIG. 3 and FIG. 5, top pocket 301 is depicted as generally an elliptical hemisphere. Top pocket 301 is positioned on top 103 at the center point CP of invention 100 such that invention 100 may be lifted stably with a crane or hoist to move the invention 100 from a first location to a second location.

As depicted in FIG. 1, a drain hole 140 is disposed with the top pocket 301. Drain hole 140 extends from the bottom point of the cavity comprising top pocket 301, through the body of invention 100 to bottom 110 so as to permit any rain or other water or liquid falling into top pocket 301 to drain away.

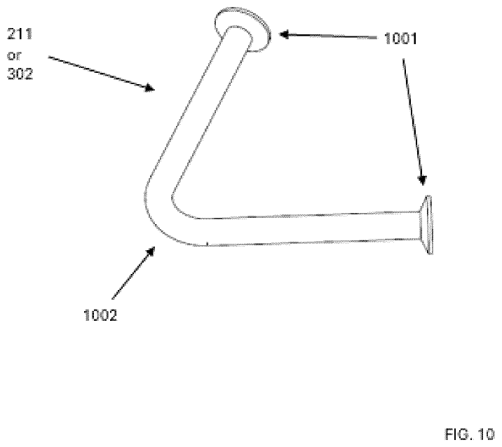

Referring to FIG. 10, a representative end anchor 211 or metal anchor 302 is comprised of a durable metal. End anchor 211 and metal anchor 302 are identical and so are described together. In practice, end anchor 211 or metal anchor 302 is formed of a single piece of metal approximately 15 inches to 18 inches long and approximately ¾ inch to 1¼ inch in diameter. The dimensions of end anchor 211 or metal anchor 302 may be varied based on the weight of invention 100 in which it is disposed. In practice, end anchor 211 or metal anchor 302 may be purchased from a retail or wholesale supplier and so may have some features as specified by the manufacturer. In any use, end anchor 211 or metal anchor 302 must be of a sufficient size to perform its intended function of supporting a substantial weight while maintaining its position partially encases in concrete. End anchor 211 or metal anchor 302 has a generally circular cross-sectional shape. In use, end anchor 211 or metal anchor 302 has a body 1002 which is formed or bent into an arcuate shape. Each end of end anchor 211 and metal anchor 302 takes the form of a spherical or hemispherical protrusion 1001 having a cross-sectional size larger than the diameter of body 1002 of end anchor 211 or metal anchor 302. End anchor 211 or metal anchor 302 is partially disposed in the concrete body 104 of invention 100 in a manner in which each of the two spherical or hemispherical protrusions 1001 is embedded in concrete along with a portion of the body 1002 proximate to each spherical or hemispherical protrusion 1001. For metal anchor 302, a portion of body 1002 is exposed in top pocket 301. In practice, approximately ⅔^{rds} of metal anchor 302 is embedded in the concrete of invention 100, with approximately ⅓^{rd} of metal anchor 302 exposed in, in this example, top pocket 301. Of the approximately ⅔^{rds} of metal anchor 302 embedded in concrete, each protrusion 1001 is embedded generally to the same depth as the other protrusion 1001 of metal anchor 302. The portion of the metal anchor 302 embedded in concrete may vary from approximately ½ of the length of body 1002 to just over ⅔rds of body 1002 of metal anchor 302. The arcuate shape and the spherical or hemispherical protrusions 1001 of metal anchor 302 ensures metal anchor 302 remains securely disposed in invention 100 during use. The mounting of end anchor 211 is described below.

Referring again to FIG. 1, invention 100 may have a stepped structure. A step 130 may be integrated into side 101, resulting in the formation of a top block 120 in the direction of the top 103 of invention 100. As depicted in FIG. 3, step 130 is disposed along the perimeter of top block 120. Whether or not stepped, the top edge of invention 100 may be chamfered to reduce the risk of injury to a worker making contact with the invention. Chamfers may be used elsewhere on invention 100 to reduce the risk of injury to workers working close to invention 100. Top block 120 may take the form of a trapezoidal solid or rectangular solid. In the preferred embodiment depicted in FIG. 1 and FIG. 2, a trapezoidal shape of top block 120 is used.

Referring to FIG. 2, an end view of invention 100 is depicted. FIG. 2 depicts a first end 201, with second end 201 disposed on the opposing end of invention 100. In the same manner as the two sides 101, each end 201 comprises a bottom width W, a top width W′ and a height H. Height H of end 201 is the same as height H of side 101. Height H of end 201 has a midpoint MH equal to the midpoint MH of side 101. In the same manner described above, end 201 may incorporate step 130 connecting end 201 to top block 120. End 201 further comprises angles Θ″ and Θ′″ similar to angles Θ and Θ′ of side 101. Relative to end 201 with the use of frame 125, angle Θ″ is formed relative to frame 125 instead of bottom 110.

Referring to FIG. 1, FIG. 2 and FIG. 4, with bottom length L and bottom width W each longer than their respective top length L′ and top width W′, along with integrated top block 120 set in by step 130, invention 100 has a center of gravity CG positioned below the midpoint MH of height H of invention 100. The trapezoidal shape and low center of gravity CG of invention 100 thus makes tipping or overturning invention 100 difficult. Further to this, bottom length Lis longer than bottom width W. As a result, it can be determined that tipping or rolling invention 100 side-to-side takes comparably less energy than tipping or rolling invention 100 end-to-end. From this, each end 201 is the more stable working end of invention 100 than either side 101.

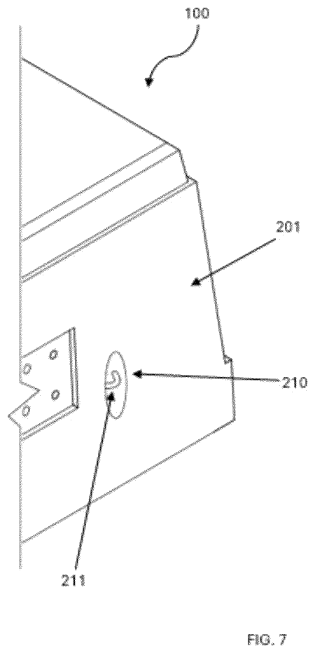

Referring to FIG. 2 and also to FIG. 3 and FIG. 7, each end 201 has disposed therein two end pockets 210 taking the form of a hemispherical cavity disposed in end 201 having a length, width and depth suitable to function as a working location for a safety anchor. In smaller embodiments of invention 100 (about 3,000 pounds), a single end pocket 210 may be disposed. While larger embodiments of invention 100 may have disposed more than two end pockets 210, two end pockets 210 is preferred. Each end pocket 210 has disposed therein an end anchor 211. Each end pocket 210 and end anchor 211 has generally the same dimensions and description as top pocket 301 and metal anchor 302. Each end pocket 210 may commonly take the form of a circular or elliptical hemisphere. End anchors 211 are disposed in end pockets 210 in generally the same manner otherwise as described for metal anchor 302 in top pocket 301.

Referring also to FIG. 1, in a preferred embodiment of invention 100, each end pocket 210 in an end 201 is generally disposed at the same height as the other above bottom 110. In FIG. 1, in a preferred embodiment, invention 100 has a height H of 29.5 inches. Each end pocket 210 is disposed in a vertical orientation between 7 inches above bottom 110 and 16 inches above bottom 110. Each end anchor 211 is disposed approximately 10 inches above bottom 110. This places each end anchor 211 at a position above bottom 110 and below midpoint MH and center of gravity CG of invention 100. Referring to FIG. 3, in a preferred embodiment in which the width of each end 201 at bottom 110 is approximately 44 inches, each end pocket 210 is disposed approximately 18 inches from each point at which end 201 connects with each side 101. The positions of end pocket 210 described in measurements herein are made from an imaginary center point of each end pocket 210 in a two dimensional rendering of such end pocket 210 from the perspective of FIG. 2. In the preferred embodiment, the two end pockets 210 are separated by approximately 8 inches.

Referring to FIG. 4 and FIG. 7, one end anchor 211 is disposed workably in each end pocket 210 in generally the same manner as top anchor 302 is disposed in top pocket 301. In a preferred embodiment, approximately ⅔rds of each end anchor 211 is embedded in the concrete of body 104 of invention 100 with a curved portion of end anchor 211 workably exposed in end pocket 210.

As depicted in FIG. 1 and depicted in detail in FIG. 3 and FIG. 8, each end anchor 211 is disposed in the concrete of invention 100 perpendicularly to the angle of the surface of end 201 relative to the angle Θ between end 201 and side 101 Thus, because of the trapezoidal shape of side 101 and angle Θ, each end anchor 211 projects in a downward direction inwardly to body 104 of invention 100 while projecting in an upward direction outwardly from invention 100, including within end pocket 210, This orientation is functional to invention 100. During use, a first end of a tether is attached using a carabiner or similar clip by a worker to the exposed portion of one end anchor 211. The worker is attached to the second end of a tether via a body harness. The tether and body harness discussed herein are standard and known in the industry. The tether may be referred to as a lanyard. In the event of a fall, the first end of the tether attached to end anchor 211 will feel a force in a generally downward direction (that is, in the direction of gravity). The slight upward orientation of end anchor 211 in the outward direction as described causes force to be directed by end anchor 211 against a larger portion of concrete in body 104 of invention 100 than if end anchor 211 was oriented parallel to bottom 110. This reduces the likelihood of end anchor 211 working loose from invention 100.

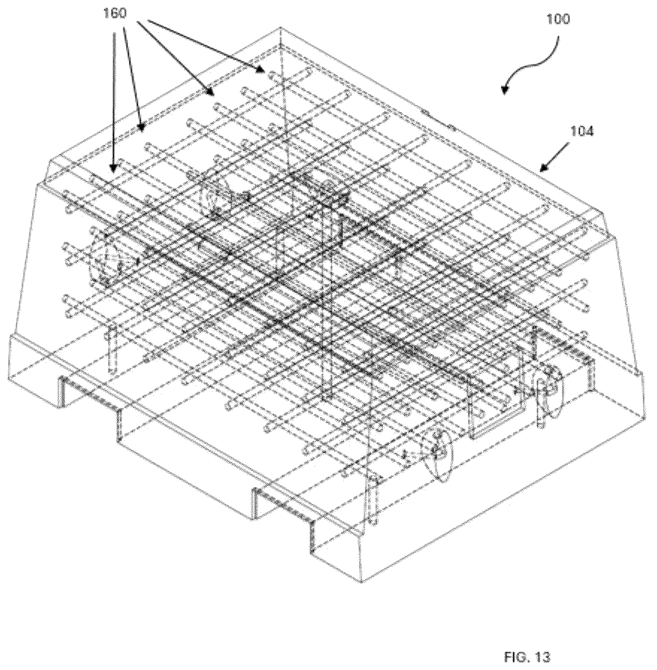

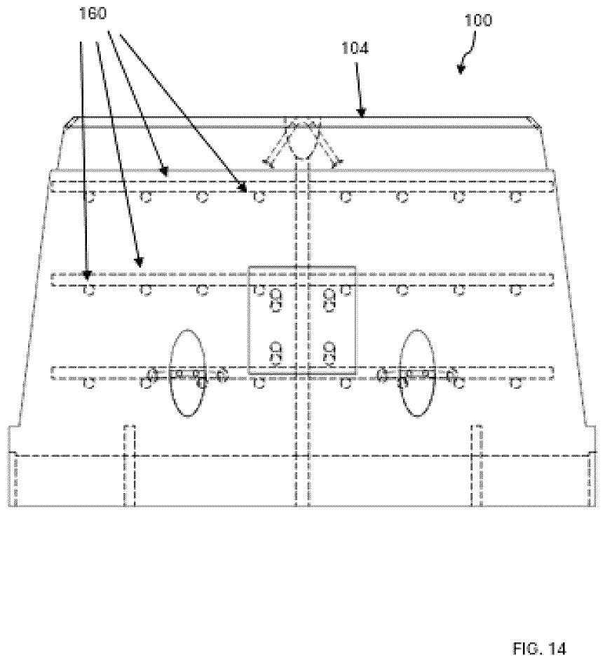

As depicted in FIG. 13 and FIG. 14, a plurality of rebar elements 160 may be disposed in invention 100 to provide structural support for body 104 of invention 100. Although rebar elements 160 may be placed in a variety of locations and orientations in invention 100, in a preferred embodiment, a plurality of rebar elements 160 are disposed within the body 104 of invention 100 lengthwise and widthwise. In FIG. 13, eight bars of rebar 160 are disposed (in dotted line representation to show positions) and eight bars of rebar 160 are disposed widthwise (also in doted line representation to show positions). Referring to FIG. 14, a plurality of layers of rebar 160 may be used. In different embodiments of invention 100, more or fewer bars of rebar 160 may be used. Rebar 160 used in invention 100 is the type commonly used in construction. Two or more bars of rebar 160 may be tied together at points at which they are in contact with one another. Tying bars of rebar 160 is commonly known in a variety of industries, and tying as described herein is done in the same manner as is known.

Referring to FIG. 4, bars of rebar 160 may be used in invention 100 to provide support to a davit mount 170 in each end 201. As depicted in FIG. 4, a davit mount 170 comprises a flat, generally square piece of steel having four corners and being approximately 8 inches to 12 inches square and ¼ to ½ inch thick. Referring also to FIG. 1 and FIG. 3, one bar of rebar 160 having a length of between 12 inches and 18 inches is welded or otherwise fixedly attached near each corner of davit mount 170. Davit mount 170 has an inner face on which the four rebars 160 are affixed and an outer face which remains exposed out when davit mount 170 is mounted on invention 100. When constructing the invention 100, the inner face of davit mount 170 and the four bars of rebar 160 are disposed inwardly into the body 104 of invention 100 such that outer face projects outwardly from invention 100. Davit mount 170 may be mounted parallel to end 201 in which it is disposed or mounted in an orientation which is perpendicular to bottom 110. Davit mount 170 may be disposed flush with end 201 or slightly protruding from end 201.

Davit mount 170 and affixed rebar 160 when positioned in end 201 serve a secondary purpose of providing structural support for each of the metal anchors 211.

Referring to FIG. 15, steel frame 125 is depicted. Steel frame 125 is comprised of two pieces of angled steel 1501 having a length L″ approximately the same as bottom side length L of side 101. Each piece of angled steel 1501 has a side element 1505 and bottom element 1506 sized to provide support for the body 104 of invention 100. Typically, side element 1505 and bottom element 1506 of angled steel 1501 is 4 inches to 8 inches wide but is commonly approximately 6 inches. Steel frame 125 further comprises two slot frames 1503 sized and shaped to act as frames for enabling the ability to lift the invention 100 with a forklift. To assemble steel frame 125, the pieces of angled steel 1501 are placed in parallel to each other with the bottom element 1506 of each laid in the direction of the other. The side elements 1505 of each is pointed vertically. Two slot frames 1503 are positioned between the two pieces of angled steel 1501 in a perpendicular manner and positioned to allow the steel frame 125 to allow use of a forklift to lift invention 100. These elements are welded together in a manner commonly known in the industry. Four lift holes 1508 are cut into side elements 1505. In some embodiments bottom elements 1506 within lift holes 1508 are left intact. In other embodiments they may be removed. Portions of each piece of angled steel 1501 and slot frames 1503 may be cut away or notched to ensure steel frame 125 lies flat on the ground when assembled.

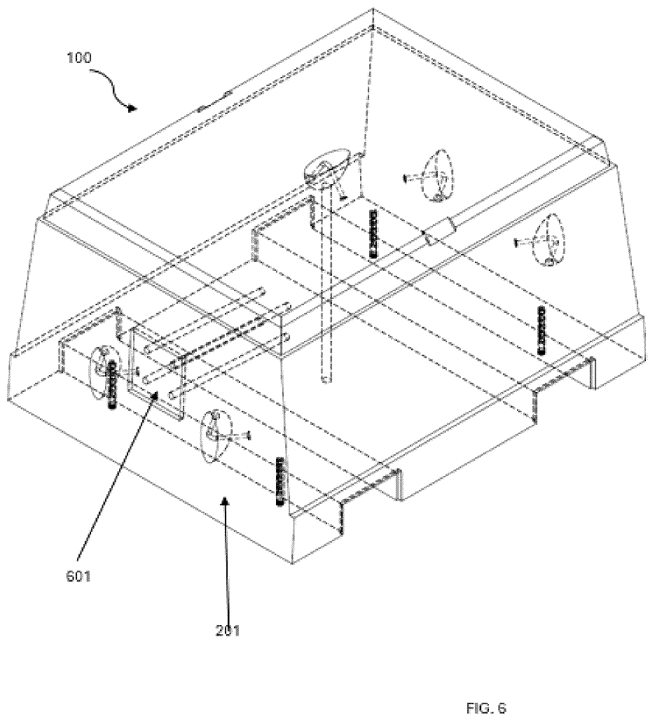

Referring to FIG. 4, a davit anchor 171 may welded to davit mount 170. Tools, such as a davit, may be used with invention 100 by attaching it to the davit anchor 171 to help secure workers or, when needed, to be used to raise fallen workers to safety. Referring to FIG. 4 and FIG. 6, to use invention 100 in its preferred embodiment, a first worker may put on a body harness or body belt. A tether is connected to the body harness or body belt at one end. The other end of the tether is then connected to one of the two end anchors 211 on the invention 100. The invention 100 is placed proximal to a leading edge. The worker may then work near the leading edge. In the event of a fall, the tether connected to each of the invention 100 and either a body harness or body belt prevents the worker from falling more than the distance of the length of the tether. The weight of invention 100 ensures invention 100 remains in its desired position.

In optional use, a second worker may put on a body harness or body belt and connect the body harness or body belt to a tether, which is then connected to the second end anchor 211 of the invention 100. If the second worker likewise falls over a leading edge, the weight of the invention 100 permits the invention 100 to remain in position ever if two workers fall.

A davit or other tool attached to the davit anchor 171 permits a winch or other tool to hoist a fallen worker back to the workspace.

Optional embodiments of the invention 100 additional end pockets 210 and end anchors 211 to be used. Optional embodiments likewise permit one or more sides 101 to have side pockets and side anchors disposed therein as described for end pockets 210 and end anchors 211. In optional embodiments, the size and/or orientation of the end anchors 211 may be modified away from their description as perpendicular to the end 201 in which the end anchor 211 is placed. Additional optional embodiments permit the use of additional rebar elements 150 to be disposed in the concrete body of the invention 100 for additional structural support. In some embodiments, the shape of invention 100 may be a rectangular solid and not a trapezoidal solid. Further, embodiments of the invention 100 may be made which do not comprise a top block 120.

We claim:

1. A device suitable to provide anchorage for a safety line connection of a worker's fall restraint harness comprising:
a heavy body in the shape generally of a trapezoidal solid having a top, a bottom, two sides and two ends;
wherein the bottom of the sides of the body have a length and the bottom ends have a width;
wherein the length of the bottom of each side is longer than the width of the bottom of each end;
wherein the top of each side has a length smaller than the length of the bottom of each side and the top of each end has a width smaller than the width of the width of the bottom of each end;
wherein the heavy body has a height equal to or smaller than the width of the bottom of each end;
wherein there is imposed an angle between each end and the bottom between 80 degrees and 89 degrees;
wherein each end has disposed therein at least one pocket sized and shaped to retain an arcuate metal anchor disposed partially in the heavy body with a portion of the arcuate metal anchor exposed workably externally in the pocket;
wherein the at least one pocket is disposed in each end at a position below a mid-point of the height of the device; and
wherein the arcuate metal anchor disposed in the at least one pocket is oriented horizontally across the end relative to the bottom and perpendicularly to the end.

2. The device of claim 1 wherein the heavy body is made of a resilient, solid material.

3. The device of claim 2 wherein the resilient, solid material is concrete.

4. The device of claim 1 wherein the weight of the device is between 3,000 pounds and 7,000 pounds.

5. The device of claim 2 wherein the resilient, solid material of the heavy body is reinforced internally with a plurality of reinforced bars.

6. The device of claim 1 wherein the heavy body has disposed partially across the bottom and partially across the sides a metal frame.

7. The device of claim 1 wherein each pocket disposed in each end has a perimeter in the shape of one of a circle or ellipse.

8. The device of claim 1 wherein the heavy body has a center of gravity having a height above the bottom lower than the midpoint of the height of the heavy body.

9. The device of claim 8 wherein each arcuate metal anchor disposed in each end is positioned lower than the center of gravity of the heavy body.

10. The device of claim 1 wherein a pocket is disposed on the top in a position over the center of gravity of the heavy body.

11. The device of claim 10 wherein an arcuate metal anchor is disposed in the pocket of the top of the device in which a portion of the arcuate metal anchor is workable exposed in the pocket of the top.

12. The device of claim 10 wherein a drain hole is disposed in the pocket of the top of the device and through the heavy body of the device to permit drainage of all liquids which may enter the pocket of the top of the device.

13. The device of claim 1 wherein two channels are disposed into the bottom of the device and across the width of the device suitable to engage the forks of a forklift.

14. The device of claim 1 wherein a davit mount is fixedly disposed in at least one end of the device.

15. The device of claim 14 wherein the davit mount is mounted parallel to the end in which it is mounted.

16. The device of claim 14 wherein the davit mount is mounted perpendicular to the bottom of the device.
